(19) United States
(12) Patent Application Publication
(10) Pub. No.: US 2014/0211584 A1
(43) Pub. Date: Jul. 31, 2014

(54) Immersion Blender with Safety Interlock Tilt Switch

(71) Applicant: Jason R. Glasgow, Newton, MA (US)

(72) Inventor: Jason R. Glasgow, Newton, MA (US)

(21) Appl. No.: 13/753,462

(22) Filed: Jan. 29, 2013

(51) Int. Cl. B01F 13/04

(52) U.S. Cl. CPC B01F 13/045
USPC 366/129

(57) ABSTRACT

The immersion blender enables the quick whipping-up of soups, sauces and other soft foods directly in a pot or serving bowl. The mincer attachment, sometimes interchangeable with a whisk, snaps onto a foot long shaft and is powered up to several hundred watts with a button that responds to the pressure of a thumb. The immersion blender is designed to be used vertically or with a tilt of several degrees when moving the blender around a pot. The safety interlock tilt switch prevents injury when an operator tilts the blender to examine the blade.

The immersion blender enables the quick whipping-up of soups, sauces and other soft foods directly in a pot or serving bowl. The mincer attachment, sometimes interchangeable with a whisk, snaps onto a foot long shaft and is powered up to several hundred watts with a button that responds to the pressure of a thumb. The immersion blender is designed to be used vertically or with a tilt of several degrees when moving the blender around a pot.

It is not uncommon for the blender blade to get jammed by a particularly hard piece of food, ice, or stringy material like hair. When this happens, the safest behavior is to remove the mixer from the pot or serving bowl, unplug the mixer from the power source, and then attempt to dislodge the food item interfering with proper operation. Often in haste, the operator neglects to unplug the mixer, and thus is exposed to the mixer blade. As long as the power switch is not unintentionally pressed, this does not present a problem. If though, the power switch is inadvertently pressed while the operator is removing the stuck food item, serious injury can occur.

This patent proposes a mechanism for preventing accidental injury to the operator of an immersion blender by means of a tilt safety switch (3) (FIG. 1) which disables the motor (6) whenever the immersion blender is not within several degrees of vertical. Since there is never a situation in which the user would attempt to use the blender while oriented horizontally, or upside down, the safety switch will not interfere with the regular functioning of the mixer. In the immersion blender, the operator starts the motor by depressing the on/off switch (2). If the immersion blender is not right side up and vertical, the tilt switch is left in an open position and the relay (4) is not energized. In order to alert the operator that the operation is unsafe, the safety switch will provide haptic feedback via a vibrator (5) whenever the safety switch has prevented the accidental operation of the motor. This haptic feedback, a vibration, or audio warning, will serve to educate the operator about the unsafe behavior, and encourage the unplugging of the device when cleaning or unjamming it. The haptic feedback is important to prevent the operator from developing an over reliance on the safety switch and a false sense of safety when using a similar mixer without such a feature. The relay operates in a fail safe mode. If the tilt switch (3) is broken or the relay (4) is not powered, the blender will by default enable the haptic vibrator (5) instead of the motor (6). The relay is designed to work on line voltage (120V) and alternating current. It includes all the electronics necessary to prevent arcing when the switches are opened.

### BRIEF DESCRIPTION OF FIGURES

FIG. 1 shows the electronics necessary in the immersion blender with a safety switch, and

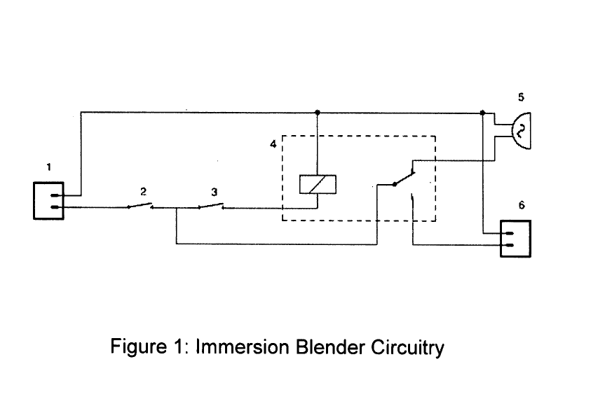

FIG. 2 is a rough sketch of the immersion blender with the circuitry contained inside.

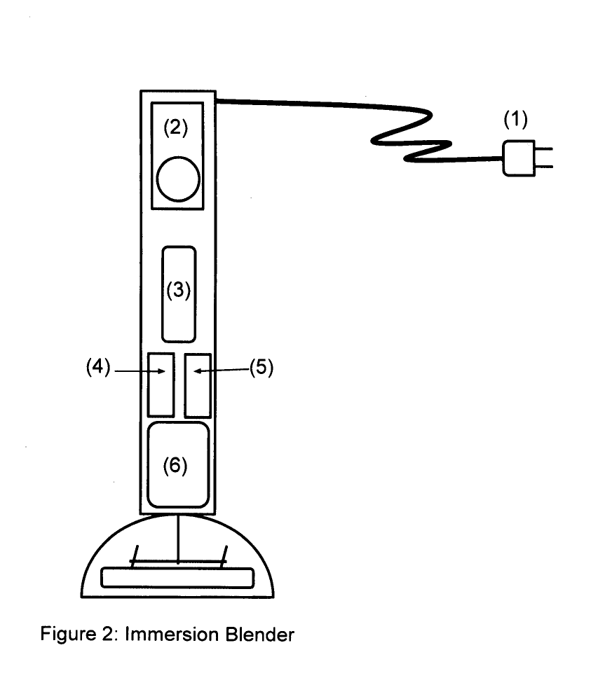

The components, numbered identically in both drawings, are:

1. Plug which connects to outlet.

2. User operated switch to turn on or off the blender.

3. Tilt switch. Closed within 15 degrees of vertical, otherwise open.

4. Alternating current relay, connected via both switches wired in serial to the live electrical wire. When the relay is not energized, the internal switch connects to the upper contact.

5. Haptic Vibrator.

6. The blender motor.

What is claimed is:

1. In an immersion blender, a tilt safety switch which disables operation of the immersion blender motor when the immersion blender is titled more than a certain amount, typically 15 degrees, from vertical.

2. A blender according to claim 1, wherein an operator feedback device communicates to the operator whenever the safety tilt safety switch is used to disabled the motor. The operator feedback device can be one of several different methods, including, but not limited to:
A haptic vibration of the entire immersion blender
An audio alert such as a buzzer, and ringing sound, or a voiced warning. The voice warning could be “disconnect power cord immediately” and can be configured for many languages.
The feedback only activates when the immersion blender is connected to power, the operator switch is in the ON position, and the blender is tilted from vertical.
